(19) United States
(12) Patent Application Publication
(10) Pub. No.: US 2015/0321283 A1
(43) Pub. Date: Nov. 12, 2015

(54) TIP DRESSING SYSTEM WITH DRESSING DEVICE FOR CUTTING ELECTRODE TIPS OF SPOT WELDING GUN

(71) Applicant: FANUC CORPORATION, Minamitsuru-gun (JP)

(72) Inventors: Masanobu Hatada, Yamanashi (JP); Toshimichi Aoki, Yamanashi (JP)

(73) Assignee: FANUC CORPORATION, Minamitsuru-gun (JP)

(21) Appl. No.: 14/705,540

(22) Filed: May 6, 2015

(30) Foreign Application Priority Data
May 9, 2014 (JP) 2014-097458

(51) Int. Cl. B23K 11/30; B23Q 17/20; B23Q 17/09

(52) U.S. Cl. CPC B23K 11/3063; B23Q 17/0995; B23Q 17/20

(57) ABSTRACT

In a tip dressing system having a welding gun, a dressing device, and a control device, the control device comprises a detection part which detects an increment amount of a load applied to a servo motor of the dressing device, a judgment part which judges if the increment amount of the load reaches a predetermined threshold value, an acquisition part which acquires a position of a movable electrode which is measured by an encoder of a servo motor for driving cutting blades of the dressing device, and a calculation part which calculates the cutting amount of the electrode tips based on the distance covered by the movable electrode moves when it is moved toward the counter electrode from the position where the increment amount of the load reaches the threshold value.

### BACKGROUND OF THE INVENTION

1. Field of the Invention

The present invention relates to a tip dressing system with a dressing device for cutting electrode tips of a spot welding gun.

2. Description of the Related Art

Spot welding systems with welding guns installed on articulated robots are widespread. Most spot welding guns are provided with a movable electrode which is driven by a servo motor and a counter electrode which faces the movable electrode, and are configured to weld base materials arranged between the two electrodes by applying a large current to the two electrodes while pressing the base materials by the front end parts of the two electrodes. The front end parts of the two electrodes are also called “electrode tips”. If such a spot welding gun is repeatedly used, there may be reduction of current densities in the electrodes tips due to deformation and wear of the electrode tips as well as oxide films deposited on the electrode tips etc., and hence deterioration of welding quality. For this reason, the electrode tips of the spot welding gun have to be periodically cut, polished, or otherwise shaped. This shaping is also called “tip dressing”. In this regard, after tip dressing, the electrodes are decreased in dimensions, and therefore the positions of the electrode tips end up gradually changing from the initial positions. For this reason, it is important to accurately detect the cutting amount of the electrodes resulted from the tip dressing and thereby identify the current positions of the electrode tips.

In relation to this, JP2002-219581A proposes the technique of detecting the positions of the movable electrode where the movable electrode and the counter electrode are closed together both before the tip dressing is started and after the tip dressing is completed, and then calculating the cutting amount of the electrode tips from the positions of the movable electrode at the two points of time. In this regard, in the technique of P2002-219581A, it is necessary to perform the process of closing together the movable electrode and the counter electrode both before the tip dressing is started and after the tip dressing is completed, and therefore the cycle time of tip dressing ends up being longer.

Further, JP2009-090316A proposes the technique of detecting the position of a movable electrode when a contact pressure between the electrode tips and the cutting blades reaches a predetermined value, and then calculating the movement distance covered by the movable electrode when it is moved from that position, as the cutting amount of the electrode tips. That is, the technique of JP2009-090316A deems the position of a movable electrode when the contact pressure between the electrode tip and the cutting blades reaches a predetermined value, as the start position of the cutting. Further, the judgment of whether the contact pressure between the electrode tip and the cutting blades has reached the threshold value is generally performed by monitoring the current value or drive torque value of the servo motor which drives the movable electrode. However, the spot welding gun has a power transmission part with a complicated structure, and hence there may be increase in the fluctuation of the current value and drive torque value of the servo motor due to the internal friction and elastic deformation of the power transmission part and other mechanical resistance.

Further, if the rigidity of the power transmission part of the spot welding gun is low, part of the reaction force which is applied to the servo motor from the cutting edge through the movable electrode is absorbed by the power transmission part. This results in a small amount of change in the current value or drive torque value of the servo motor. For this reason, the increment amount of the current value or drive torque value for gradually increasing the contact pressure between the movable electrode and the cutting edge may be concealed by the fluctuation due to the mechanical resistance, and therefore it is difficult to accurately determine the contact pressure. This may cause false detection of the cutting start position. If the above threshold value is increased for the purpose of preventing the false detection, there may be a higher possibility that the cutting is started before the current value or drive torque value reaches the threshold value, and therefore the cutting amount calculated by the above-mentioned technique ends up greatly deviating from the actual cutting amount. Furthermore, there are diverse types of power transmission parts in commercially available spot welding guns, and therefore, in order to accurately detect the above-mentioned cutting start position, it is necessary to conduct experiments to determine the threshold value of the current value or drive torque value as the threshold value differs for each type of spot welding gun. Further, a spot welding gun installed to a spot welding system is operated at a high frequency, and therefore it is very likely that the behavior of the current or drive torque of the servo motor will be changed due to deterioration over time of the spot welding gun even if a suitable threshold is predetermined.

A tip dressing system which is capable of accurately calculating the cutting amount of the electrode tips is being sought.

### SUMMARY OF INVENTION

According to a first aspect of the present invention, there is provided a tip dressing system comprising: a spot welding gun which has a movable electrode, a counter electrode which faces the movable electrode, a servo motor which moves the movable electrode with respect to the counter electrode, and an encoder which measures a position of the movable electrode, a dressing device which has cutting blades for cutting the front end parts of the movable electrode and the counter electrode, and a servo motor which drives the cutting blades, and a calculation device which calculates a cutting amount when the cutting blades cut the front end parts of the movable electrode and the counter electrode, wherein the calculation device comprises a detection part which detects an increment amount of load which is applied to the servo motor of the dressing device, a judgment part which judges if the increment amount of the load has reached a predetermined threshold value, an acquisition part which acquires the position of the movable electrode which is measured by the encoder, and a calculation part which calculates the cutting amount based on the distance which is covered by the movable electrode when the movable electrode is moved toward the counter electrode from the position where the increment amount of the load reaches the threshold value.

According to a second aspect of the present invention, there is provided a tip dressing system in the first aspect, wherein the detection part detects the increment amount of the load, based on an increment amount of the current value through the servo motor of the dressing device or an increment amount the drive torque value which is generated by the servo motor of the dressing device.

According to a third aspect of the present invention, there is provided a tip dressing system in the first or second aspect, wherein the detection part detects the increment amount of the load per unit time.

According to a fourth aspect of the present invention, there is provided a tip dressing system in any one of the first to third aspects, wherein the detection part detects the increment amount of the load from a predetermined reference value.

According to a fifth aspect of the present invention, there is provided a tip dressing system in any one of the first to fourth aspects, wherein the calculation part repeatedly calculates the cutting amount at a predetermined cycle.

According to a sixth aspect of the present invention, there is provided a tip dressing system in the fifth aspect, wherein the calculation device further comprises a first control part which compares the cutting amount repeatedly calculated by the calculation part with a predetermined target value to stop the servo motor of the dressing device when the cutting amount reaches the target value.

According to a seventh aspect of the present invention, there is provided a tip dressing system in the sixth aspect, wherein the calculation device further comprises a second control part which inverts the rotational direction of the servo motor of the spot welding gun to move the movable electrode in a direction away from the counter electrode when the cutting amount repeatedly calculated by the calculation part reaches the target value.

According to an eighth aspect of the present invention, there is provided a tip dressing system in any one of the first to seventh aspects, wherein the calculation device further comprises: a time measuring part which measures an elapsed time during which the cutting blades cut the front end parts of the movable electrode and the counter electrode, and a first alarm part which outputs an alarm when the measured elapsed time has reached a predetermined upper limit time.

According to a ninth aspect of the present invention, there is provided a tip dressing system in any one of the first to eighth aspects, wherein the calculation device further comprises a distribution part which distributes the cutting amount calculated by the calculation part at a predetermined ratio to calculate a cutting amount on the movable electrode side and a cutting amount on the counter electrode side.

According to a 10th aspect of the present invention, there is provided a tip dressing system in the ninth aspect, wherein the calculation device further comprises a memory part which stores time series data of the cutting amount, the cutting amount on the movable electrode side, and the cutting amount on the counter electrode side.

According to an 11th aspect of the present invention, there is provided a tip dressing system in the 10th aspect, further comprising a display device which can display the time series data.

According to a 12th aspect of the present invention, there is provided a tip dressing system in any one of the first to 11th aspects, wherein the calculation device further comprises a distance measuring part which measures a distance between a position of the movable electrode when the increment amount of the load reaches the threshold value, and a predetermined initial position of the movable electrode, and a third control part which stops the servo motor of the dressing device when the distance measured by the distance measuring part exceeds a predetermined upper limit distance.

According to a 13th aspect of the present invention, there is provided a tip dressing system in the 12th aspect, wherein the calculation device further comprises a second alarm part which outputs an alarm when the distance measured by the distance measuring part exceeds the upper limit distance.

These and other objects, features, and advantages of the present invention will become clearer with reference to the detailed description of illustrative embodiments of the present invention which are shown in the attached drawings.

### BRIEF DESCRIPTION OF THE DRAWINGS

FIG. 1 is a side view which shows the appearance of an illustrative tip dressing system of one embodiment of the present invention.

FIG. 2 is a partial enlarged view which shows the main body and its vicinity of a dressing device in FIG. 1.

FIG. 3 is a first schematic view which shows in a time series manner, a procedure in which the dressing device of FIG. 2 cuts a movable electrode tip and a counter electrode tip.

FIG. 4 is a second schematic view which shows in a time series manner, a procedure in which the dressing device of FIG. 2 cuts a movable electrode tip and a counter electrode tip.

FIG. 5 is a third schematic view which shows in a time series manner, a procedure in which the dressing device of FIG. 2 cuts a movable electrode tip and a counter electrode tip.

FIG. 6 is a block diagram which shows a system configuration of a control device in the tip dressing system of FIG. 1.

FIG. 7 is a graph which shows a temporal change of a rotational speed of a cutting servo motor in an illustrative tip dressing process.

FIG. 8 is a graph which shows a temporal change of a current value of a cutting servo motor in an illustrative tip dressing process.

FIG. 9 is a first graph which shows a temporal change of a current value of current through a cutting servo motor, similar to FIG. 8.

FIG. 10 is a second graph which shows a temporal change of a current value through a cutting servo motor, similar to FIG. 8.

FIG. 11 is a schematic view which shows cross-sections of a body part in a dressing device during an illustrative tip dressing process for comparison between the cutting start time and the current time.

FIG. 12 is a flow chart which shows the procedure in which a control device calculates the total cutting amount in an illustrative tip dressing process.

### DETAILED DESCRIPTION OF EMBODIMENTS

Below, embodiments of the present invention will be explained in detail with reference to the drawings. Note that the following explanation does not limit the technical scope of the inventions which are described in the claims or the meaning of terms etc.

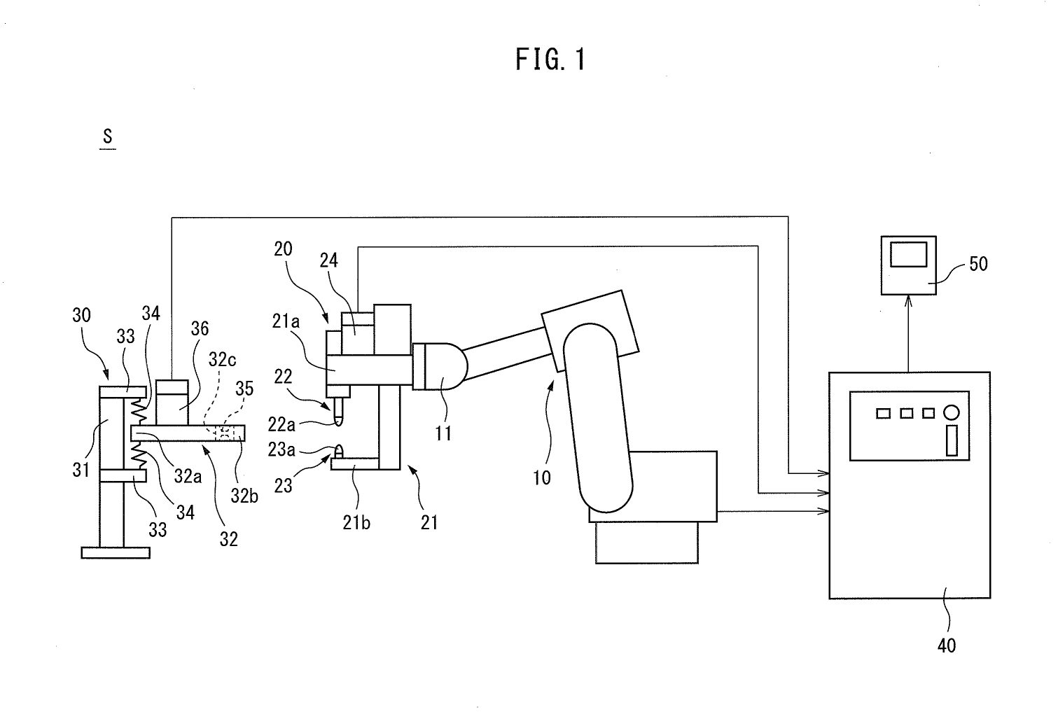

Referring to FIG. 1 to FIG. 12, the tip dressing system according to an embodiment of the present invention will be explained. The tip dressing system S of the present embodiment is an automated system which can perform the process of cutting and shaping the front end parts of the later explained movable electrode 22 and counter electrode 23. This process will be called the “tip dressing process” below. FIG. 1 is a side view which shows the appearance of an illustrative tip dressing system S. As shown in FIG. 1, the tip dressing system S of the present example includes a robot 10, a spot welding gun 20 which is attached to a wrist part of the robot 10, a dressing device 30 which is arranged adjoining the robot 10, a control device 40 which controls the operations of each device, and a display device 50 which can display various information. These devices will be explained in order below.

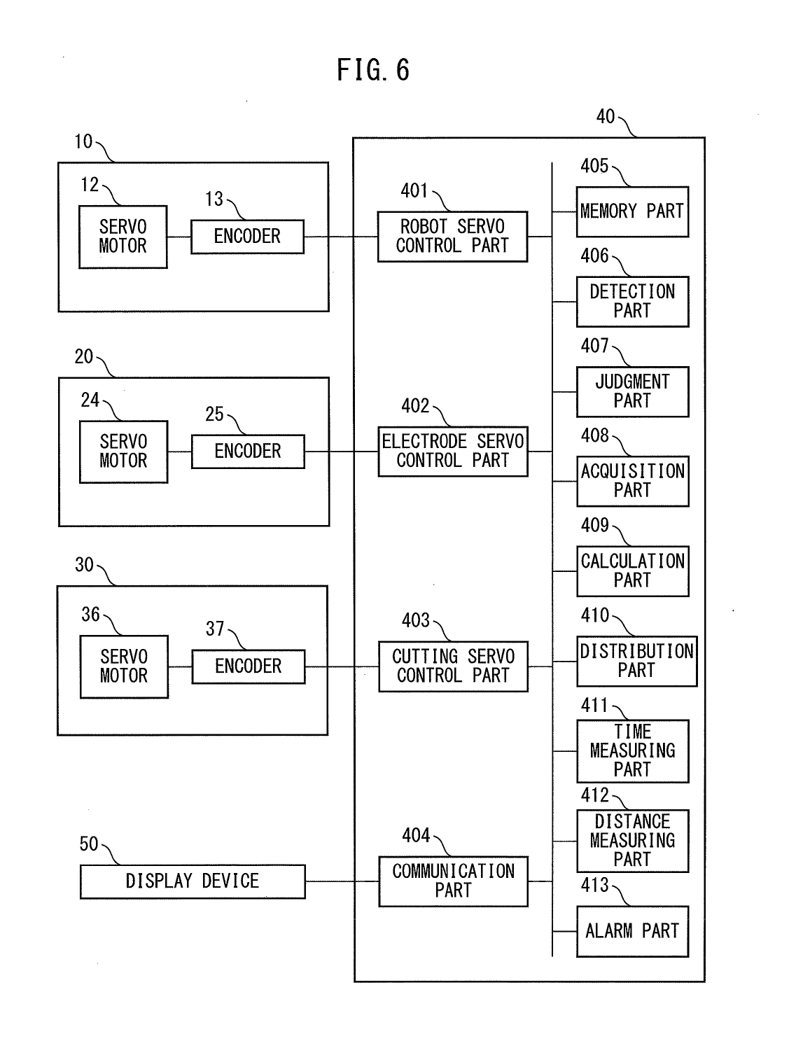

First, the robot 10 of the present example is a general vertical articulated robot. The robot 10 of the present example can freely change the position and posture of the spot welding gun 20 which is attached to the wrist part 11 by the drive power of a not shown plurality of servo motors. This ensures that the spot welding gun 20 can be positioned with respect to the welding base materials or dressing device 30 etc. In the following explanation, the servo motors of the robot 10 will sometimes be called “robot servo motors”. The robot servo motors 12 of the present example are respectively provided with encoders 13 which can measure the positions of the driven parts which are driven by them (see FIG. 6). The position information which encoders 13 of the robot servo motors 12 is transmitted to the control device 40.

Next, the spot welding gun 20 of the present example is provided with a gun arm 21 which is attached to a wrist part 11 of the robot 10 and which has a C-shaped form, a movable electrode 22 which is movably attached to one end part 21a of the gun arm 21, a counter electrode 23 which is fastened to the other end part 21b of the gun arm 21 so as to face the movable electrode 22, and a servo motor 24 which is attached to a location adjoining the movable electrode 22 at the gun arm 21 so as to drive the movable electrode 22. In the following explanation, the servo motor 24 of the spot welding gun 20 will sometimes be called the “electrode servo motor 24”. Further, the spot welding gun 20 of the present example is provided with a not shown power transmission part which transmits drive power of the electrode servo motor 24 to the movable electrode 22. This power transmission part has to convert rotational motion of the electrode servo motor 24 to linear motion of the movable electrode 22, and therefore has a complicated structure which incorporates a ball screw and toothed belt etc. Furthermore, the electrode servo motor 24 of the present example is provided with an encoder 25 which can acquire position information of the movable electrode 22 which is driven by the electrode servo motor 24 (see FIG. 6). The position information acquired by the encoder of the electrode servo motor 24 is transmitted to the control device 40.

As shown in FIG. 1, the movable electrode 22 and the counter electrode 23 of the present example have rod-shaped forms which extend along the same axial line. The movable electrode 22 of the present example is attached to the gun arm 21 so as to be able to move straight along that axial line. That is, the movable electrode 22 of the present example can be moved by the drive power of the electrode servo motor 24 both in a movement direction toward the counter electrode 23 and a movement direction away from the counter electrode 23. A spot welding gun with such a structure is generally called a “C-type spot welding gun”. Further, if the spot welding gun 20 of the present example presses welding base materials (not shown) gripped between the movable electrode 22 and the counter electrode 23 while applying current to the electrodes 22, 23, the contact portions of these base materials with the electrodes 22, 23 are fused to be locally joined with each other. In this way, the spot welding gun 20 of the present example welds base materials together. Note that, in the following explanation, the front end part of the movable electrode 22 which contacts one base material will sometimes be called a “movable electrode tip 22a”, while the front end part of the counter electrode 23 which contacts the other base material will sometimes be called a “counter electrode tip 23a”.

Next, the dressing device 30 of the present example is provided with a columnar base part 31 which is fastened to the floor and extends upward in the vertical direction, and an elliptical plate-shaped main body 32 which is connected to the base part 31 and extends in the horizontal direction. As shown in FIG. 1, a pair of horizontal brackets 33 is attached to the columnar base part 31 so as to be arranged in the vertical direction. One end part 32a in the extension direction of the main body 32 is arranged between these horizontal brackets 33. Further, a plurality of biasing springs 34 are arranged between the above end part 32a of the main body 32 and the horizontal brackets 33 to extend in the vertical direction. In this way, the main body 32 of the present example is elastically supported by a plurality of biasing springs 34 which extend in the vertical direction. These biasing springs 34 are designed to move back and forth in the vertical direction along with expanding and contracting upon receiving external force.

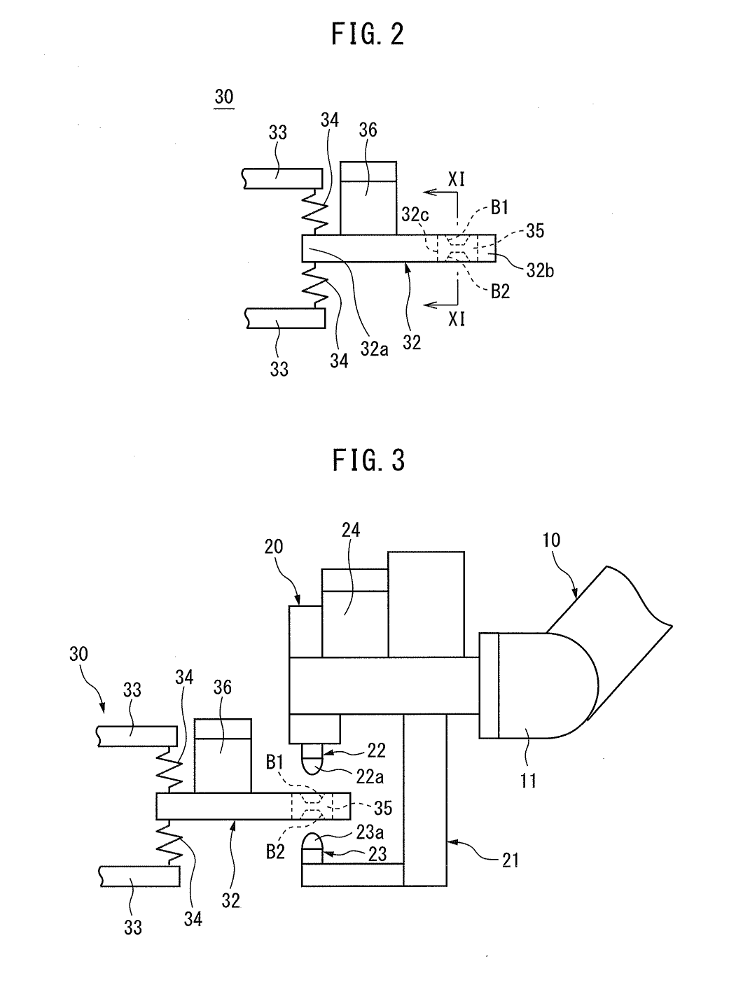

FIG. 2 is a partially enlarged view which shows the main body 32 and it vicinity in the dressing device 30 in FIG. 1. As shown in FIG. 2, the other end part 32b of the main body 32 is provided with a through hole 32c which extends in the vertical direction. A rotary type of cutting member 35 for cutting the movable electrode tip 22a and the counter electrode tip 23a is installed in the through hole 32c. Further, a servo motor 36 for driving the cutting member 35 is attached to the main body 32 of the present example. The cutting member 35 of the present example can use the drive power of the servo motor 36 to rotate about the rotation axis along the extension direction of the through hole 32c. In the following explanation, the servo motor 36 of the dressing device 30 will sometimes be referred to as the “cutting servo motor 36”. Further, a not shown power transmission part for transmitting the drive power of the cutting servo motor 36 to the cutting member 35 is built in the main body 32 of the present example. This power transmission part has a relatively simple structure which incorporates a small number of gears. Furthermore, the cutting servo motor 36 of the present example is provided with an encoder 37 which can acquire position information of the cutting member 35 which is driven by the cutting servo motor 36 (see FIG. 6). The position information acquired by the encoder 37 of the cutting servo motor 36 is transmitted to the control device 40. As shown in FIG. 2, the cutting member 35 of the present example is provided with an upward cutting blade B1 which faces upward in the vertical direction, and a downward cutting blade B2 which faces downward in the vertical direction. The upward cutting blade B1 has a shape which corresponds to the movable electrode tip 22a. Similarly, the downward cutting edge B2 has a shape which corresponds to the counter electrode tip 23a.

The dressing device 30 with the above structure can cooperate with the robot 10 and the spot welding gun 20 to simultaneously cut the movable electrode tip 22a and the counter electrode tip 23a. FIG. 3 to FIG. 5 are schematic views which show in a time series manner, a procedure in which the dressing device 30 of FIG. 2 cuts the movable electrode tip 22a and the counter electrode tip 23a. First, as shown in FIG. 3, the servo motor 36 of the dressing device 30 starts the rotational drive of the cutting member 35, and the robot 10 positions the spot welding gun 20 in the horizontal direction with respect to the dressing device 30. The “positioning in the horizontal direction” referred to here means making the movable electrode tip 22a face the upward cutting blade B1 of the cutting member 35 and making the counter electrode tip 23a face the downward cutting blade B2. However, at this point of time, the movable electrode tip 22a and the counter electrode tip 23a are sufficiently separated from each other. Therefore, neither of the electrode tips contact the cutting member 35.

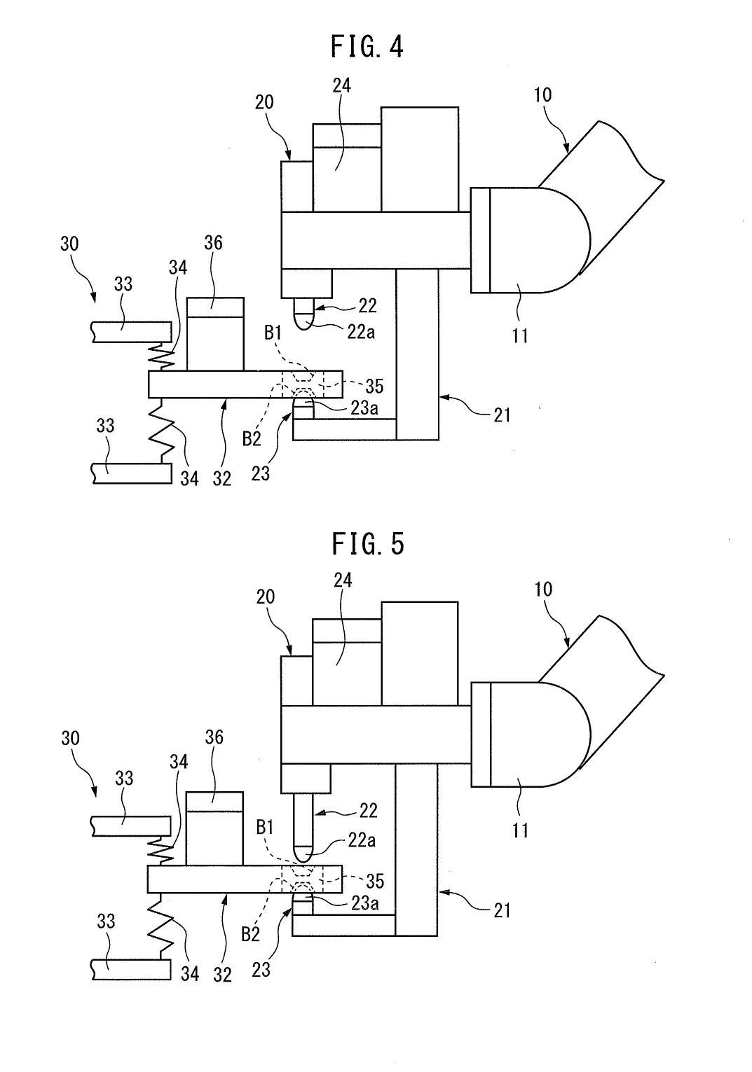

Next, as shown in FIG. 4, the robot 10 positions the spot welding gun 20 in the vertical direction with respect to the dressing device 30. The “positioning in the vertical direction” referred to here means making the counter electrode tip 23a contact the downward cutting blade B2 of the cutting member 35. However, as explained above, the main body 32 of the dressing device 30 is elastically supported by the biasing springs 34, and therefore the majority of the pressing force which is applied from the counter electrode tip 23a to the cutting member 35 is absorbed by the biasing springs 34. Therefore, at the point of time of FIG. 4, the cutting of the counter electrode tip 23a by the cutting member 35 is not started. Next, as shown in FIG. 5, the servo motor 24 of the spot welding gun 20 moves the movable electrode 22 toward the counter electrode 23, whereupon the movable electrode tip 22a comes into contact with the upward cutting blade B1 of the cutting member 35. After that, the servo motor 24 of the spot welding gun 20 further moves the movable electrode 22 toward the counter electrode 23, whereupon the contact pressure of the movable electrode tip 22a and the counter electrode tip 23a with the cutting member 35 becomes sufficiently larger. The cutting member 35 thus starts the cutting of the movable electrode tip 22a and the counter electrode tip 23a.

Referring again to FIG. 1, the control device 40 of the present example is provided with a not shown CPU, memory device, input/output interface, etc. and is configured to perform feedback control of the robot servo motor based on position information which was acquired from the encoder of the robot servo motor. Similarly, the control device 40 of the present example performs feedback control of the electrode servo motor 24 and the cutting servo motor 36 based on the position information which is acquired from the encoders of the electrode servo motor 24 and cutting servo motor 36, respectively. Further, the control device 40 of the present example has a communication function which exchanges information with an external device such as a display device 50, and is capable of outputting various alarm messages, notification signals, etc. to an external device. Furthermore, the control device 40 of the present example has the function of calculating the total cutting amount of the movable electrode tip 22a and the counter electrode tip 23a which are cut in the above-mentioned tip dressing process. The “cutting amount” referred to here means the decrement amount of dimension in the movement direction of the movable electrode 22 while the movable electrode tip 22a and the counter electrode tip 23a are cut in the tip dressing process. Next, the display device 50 of the present example is a peripheral device such as a teaching console or line control board, and is connected with the control device 40 so as to communicate with the control device 40.

Next, the system configuration of the control device 40 of the present example will be explained. FIG. 6 is a block diagram which shows the system configuration of the control device 4 in the tip dressing system S of FIG. 1. As shown in FIG. 6, the control device 40 of the present example has a robot servo control part 401 which performs feedback control of the robot servo motor 12, an electrode servo control part 402 which performs feedback control of the electrode servo motor 24, and a cutting servo control part 403 which performs feedback control of the cutting servo motor 36. In addition, the control device 40 of the present example has a communication part 404, memory part 405, detection part 406, judgment part 407, acquisition part 408, calculation part 409, distribution part 410, time measuring part 411, distance measuring part 412, and alarm part 413. These parts will be explained below in order.

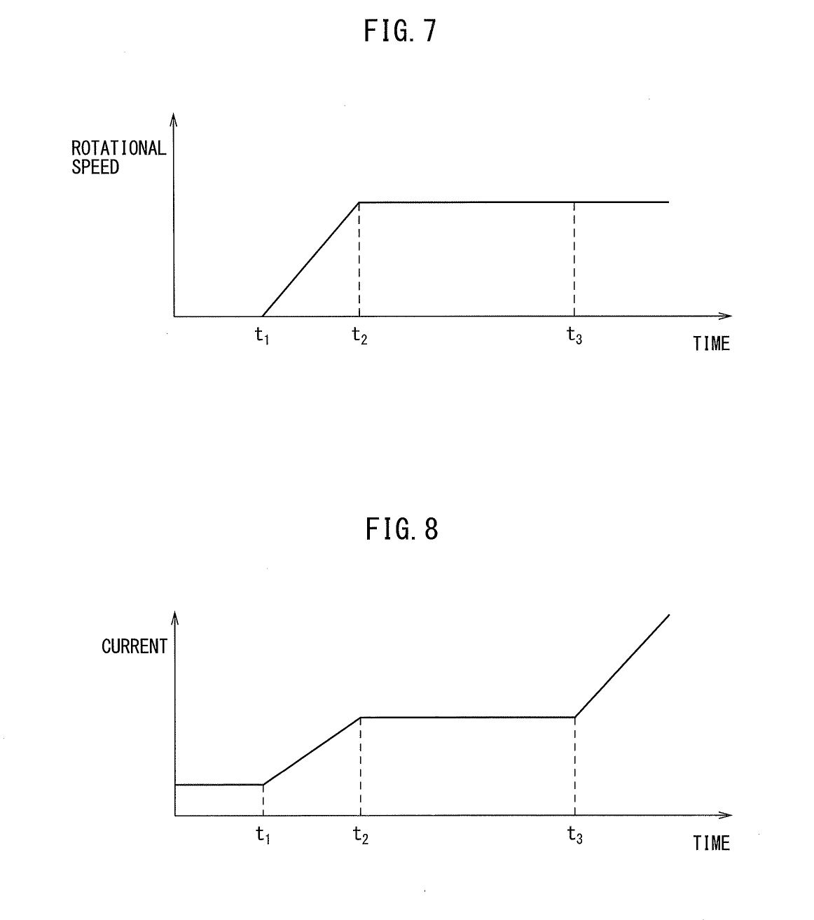

First, the communication part 404 of the present example is an input/output interface for communicating with an external device such as a display device 50. Next, the memory part 405 of the present example is a data storage area of a ROM and RAM etc. which holds a threshold value th₁ of an increment amount ΔI of a current value, a threshold value th₂ of an increment amount per unit time ΔI/Δt of the current value, a target value of a cutting amount C of the electrode tips, and other data. Details of the above values are explanted later. Next, the detection part 406 of the present example has the function of detecting the increment amount of the load which is applied to the cutting servo motor 36 of the dressing device 30. More specifically, the detection part 406 of the present example successively measures the current value through the cutting servo motor 36 or the drive torque value generated by the cutting servo motor 36, and uses the measured values to calculate the amount of increase of load which is applied to the cutting servo motor 36. The detection method of the detection part 406 of the present example detecting the increment amount of the load which is applied to the cutting servo motor 36 will be explained with reference to FIG. 7 and FIG. 8.

FIG. 7 is a graph which shows the temporary change of the rotational speed of the cutting servo motor 36 in the illustrative tip dressing process, while FIG. 8 is a graph which shows the temporal change of the current value of the cutting servo motor 36. As will be understood from FIG. 7, the cutting servo motor 36 starts up at the time t₁ to accelerate at a certain acceleration, and then continues to rotate at a certain rotational speed. The time when the cutting servo motor 36 starts rotating at a constant speed will be referred to as the time t₂. After that, even when the movable electrode tip 22a contacts the cutting member 35 at the time t₃ (see FIG. 4), the cutting servo motor 36 continues to rotate at a constant speed due to feedback control of the cutting servo control part 403. Further, as will be understood from FIG. 8, in the period from when the cutting servo motor 36 starts to rotate at a constant speed to when the movable electrode tip 22a contacts the cutting member 35, that is, in the period from the time t₂ to the time t₃, the load applied to the cutting servo motor 36 is constant, and therefore the current value through the cutting servo motor 36 is also constant. This operating state of the cutting servo motor 36 will sometimes be called the “reference state” below.

On the other hand, after the movable electrode tip 22a contacts the cutting member 35, that is, in the period from the time t₃ onward, the load applied to the cutting servo motor 36 increases in accordance with the reaction force which is applied from the electrode tips 22a, 23a to the cutting member 35, and therefore the current value of the cutting servo motor 36 is increased so as to cancel out the increment in the load. In this way, the current value of the cutting servo motor 36 increases according to the magnitude of the load, and therefore the detection part 406 of the present example successively measures the current value of the cutting servo motor 36 and uses the measured value to detect the increment amount of the load. Note that, the drive torque value which is generated by the cutting servo motor 36 is generally proportional to the current value through the cutting servo motor 36, and therefore the temporal change of the drive torque value generated by the cutting servo motor 36 is similar to the temporal change of the current value which is shown in the graph of FIG. 8. For this reason, the detection part 406 of the present example may also successively measure the drive torque value of the cutting servo motor 36, instead of the current value through the cutting servo motor 36, and use the measured value to detect the increment amount of the load.

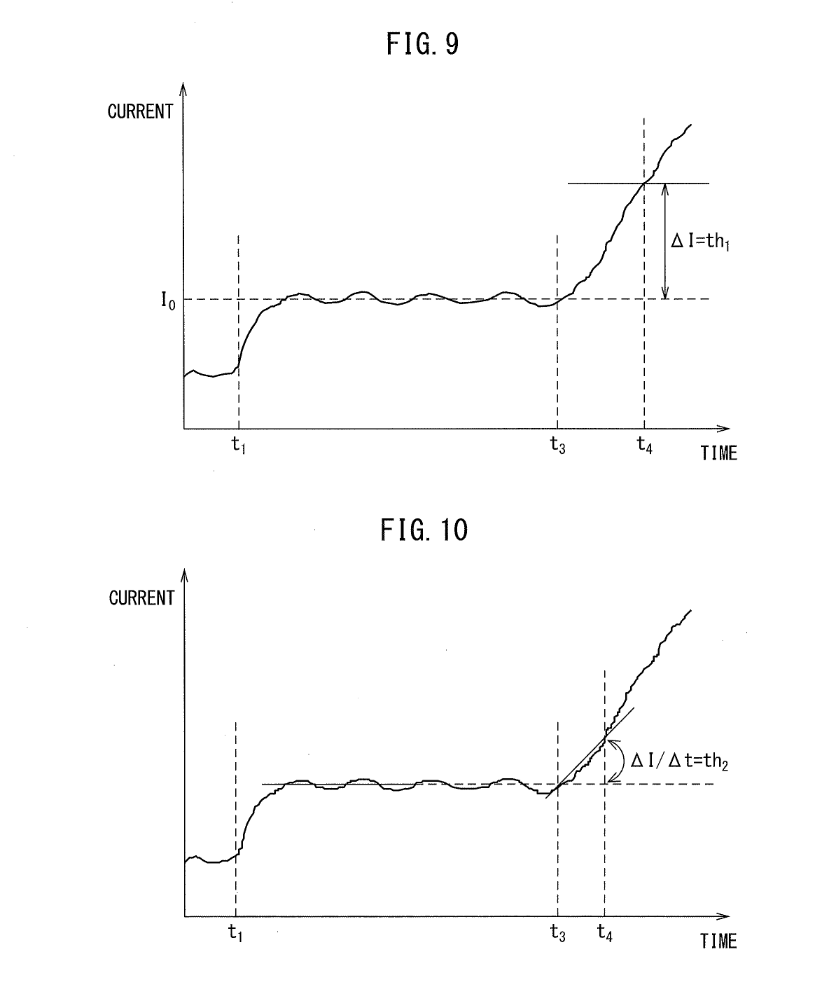

Referring again to FIG. 6, the judgment part 407 of the present example has the function of judging if the increment amount of the load of the cutting servo motor 36 which is detected by the detection part 406 has reached a predetermined threshold value. The judgment method employed by the judgment part 407 of the present example will be explained with reference to FIG. 9. FIG. 9 is a graph which shows the temporal change of the current value through the cutting servo motor 36 of the present example, similar to FIG. 8. However, the graph of FIG. 8 shows the theoretical temporal change which excludes fluctuations in current value due to internal friction and elastic deformation etc. of the power transmission part of the dressing device 30. On the other hand, the graph of FIG. 9 shows the actual temporal change which includes the above fluctuations. First, the judgment part 407 of the present example determines the current value I₀ which flows through the cutting servo motor 36 when the cutting servo motor 36 is in the above-mentioned reference state. This current value I₀ will be referred to below as the “reference current value I₀”.

More specifically, the judgment part 407 of the present example determines as the “reference current value I₀”, the average of the current values for a predetermined period if the amount of change of the load measured by the detection part 406 remains within a small range over the predetermined period. However, the reference current value I₀ which is experimentally determined by the user may also be stored in the memory part 405. Next, the judgment part 407 of the present example calculates the increment amount ΔI of the current value of the cutting servo motor 36 from the reference current value I₀, and judges if the increment amount ΔI has reached a predetermined threshold value th₁. As explained above, the tip dressing system S of the present example judges if the cutting blades B1, B2 have started the cutting of the electrode tips 22a, 23a, based on the results of judgment of the judgment part 407. More specifically, the tip dressing system S of the present example deems that cutting of the electrode tips 22a, 23a is started when the increment amount ΔI of the current value reaches the above threshold value th₁ so as to calculate the cutting amount of the electrode tips 22a, 23a. For this reason, the time t₄ when the increment amount ΔI of the current value reaches the threshold value th₁ will be referred to below as the cutting start time t₄. The threshold value th₁ of the increment amount ΔI of the current value can be experimentally determined by the user, and can be stored in the memory part 405. In this case, the user should determine the threshold value th₁ in consideration of the above-mentioned fluctuations of current value. The result of judgment of the judgment part 407 of the present example is transmitted to the acquisition part 408. The judgment part 407 of the present example repeatedly performs the above-mentioned procedure at a predetermined cycle.

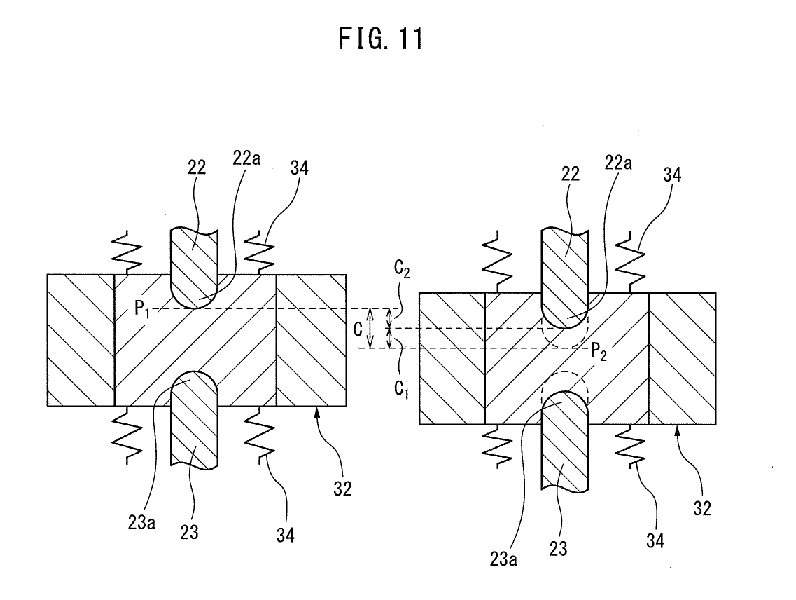

Note that, the judgment part 407 of the present example can also judge if the increment amount per unit time ΔI/Δt of the current value has reached the predetermined threshold value th₂. The method of judgment in this case will be explained with reference to FIG. 10. FIG. 10 is a graph which shows the temporal change of the current value through the cutting servo motor 36, similar to FIG. 8. As will be understood from FIG. 10, the increment amount per unit time ΔI/Δt of the current value through the cutting servo motor 36 is expressed by the slope of the graph of the temporal change of the current value. That is, the judgment part 407 of the present example may calculate the increment amount of the slope ΔI/Δt of the graph of the temporal change along of the current value from the slope at the reference state (in the example of FIG. 10, ΔI/Δt=0), and then judge if that increment amount has reached the threshold value th₂.

Referring again to FIG. 6, the acquisition part 408 of the present example has the function of acquiring the position information of the movable electrode 22 which is measured by the encoder 24 of the electrode servo motor 24. Next, the calculation part 409 of the present example has the function of calculating the total cutting amount C of the movable electrode tip 22a and the counter electrode tip 23a during the tip dressing process, in cooperation with the above judgment part 407 and acquisition part 408. More specifically, the calculation part 409 of the present example calculates the above-mentioned total cutting amount C based on the movement distance of the movable electrode 22 from the position at the cutting start time t₄ toward the counter electrode 23. The calculation method employed by the calculation part 409 of the present example to calculate the total cutting amount C will be explained with reference to FIG. 11. FIG. 11 is a schematic view which shows cross-sections of the main body 32 of the dressing device 30 during the tip dressing process for comparison between the above cutting start time t₄ and the current time after the cutting start time t₄. Note that, each cross-section in FIG. 11 is a cross-section of the main body 32 along the line XI-XI of FIG. 2. Further, the cross-section of the main body 32 at the cutting start time t₄ is shown on the left side in the figure, while the cross-section of the main body 32 at the current time is shown on the right side in the figure.

First, the acquisition part 408 of the present example acquires the position information of the movable electrode 22 from the encoder 25 when the increment amount ΔI of the current value reaches the threshold value th₁. The thus acquired position of the movable electrode 22, that is, the position P₁ of the movable electrode 22 at the cutting start time t₄, will sometimes be called the “cutting start position P₁” below (see cross-section on the left side of FIG. 11). Next, the acquisition part 408 of the present example acquires the position information of the movable electrode 22 at the current time from the encoder 25. The position P₂ of the movable electrode 22 at the current time will sometimes be referred to below as the “current position P₂” (see cross-section at right side of FIG. 11). Next, the calculation part 409 of the present example calculates the distance between the cutting start position P₁ and the current position P₂ of the movable electrode 22. In the tip dressing process of the present example, the thus calculated movement distance C of the movable electrode 22 is deemed as the total cutting amount of the movable electrode tip 22a and the counter electrode tip 23a. The acquisition part 408 and calculation part 409 of the present example repeatedly perform the above-mentioned procedure at a predetermined cycle. The total cutting amount C repeatedly calculated by the calculation part 409 of the present example is transmitted to the division part 410.

Referring again to FIG. 6, the total cutting amount C repeatedly calculated by the calculation part 409 is also transmitted to the above cutting servo control part 403 and electrode servo control part 402. Further, the cutting servo control part 403 and the electrode servo control part 402 can use the received total cutting amount C to control the operations of the cutting servo motor 36 and the electrode servo motor 24. For example, the cutting servo control part 403 compares the total cutting amount C repeatedly calculated by the calculation part 409 and a predetermined target value, and stops the cutting servo motor 36 when the total cutting amount C reaches the target value. This ensures that the cutting member 35 is stopped immediately after the total cutting amount C reaches the target value, and therefore it is possible to prevent the movable electrode 22 and the counter electrode 23 from being excessively cut beyond the target value. Further, the electrode servo control part 402 compares the total cutting amount C repeatedly calculated by the calculation part 409 and the above target value and inverts the rotational direction of the electrode servo motor 24 to move the movable electrode 22 in a direction away from the counter electrode 23 when the total cutting amount C reaches the target value. This ensures that the movable electrode 22 is separated from the cutting member 35 immediately after the total cutting amount C reaches the target value, and therefore it is possible to prevent the movable electrode 22 and the counter electrode 23 from being excessively cut beyond the target value.

Next, the distribution part 410 of the present example has the function of distributing the total cutting amount C repeatedly calculated by the calculation part 409 into a cutting amount C₁ on the movable electrode 22 side and a cutting amount C₂ on the counter electrode 23 side, using various methods. More specifically, the distribution part 410 of the present example calculates the cutting amount C₁ on the movable electrode 22 side and the cutting amount C₂ on the counter electrode 23 side by multiplying the total cutting amount C by a predetermined distribution ratio (see FIG. 11). However, the distribution method employed by the distribution part 410 of the present example may be any known distribution method. Further, the cutting amount C₁ on the movable electrode 22 side and the cutting amount C₂ on the counter electrode 23 side which are successively calculated by the distribution part 410 of the present example are stored in the memory part 405 together with the total cutting amount C. Therefore, the memory part 405 stores time series data of the cutting amount C₁ on the movable electrode 22 side, the cutting amount C₂ on the counter electrode 23 side, and the total cutting amount C. The content of such time series data can be displayed by the display device 50.

Next, the time measuring part 411 of the present example has the function of measuring the elapsed time during which the cutting member 35 of the dressing device 30 performs the cutting of the electrode tips 22a, 23a. More specifically, the time measuring part 411 of the present example has the function of measuring the elapsed time from the cutting start time t₄ onward. Here, in the case where the total cutting amount C does not reach the above target value although the elapsed time from the cutting start time t₄ onward exceeds the predetermined upper limit time, there may be a slip between the cutting blades B1, B2 and the electrode tips 22a, 23a which is caused by a drop in cutting ability of the cutting blades B1, B2 due to deterioration over time. Alternatively, there may be a slip between the cutting blades B1, B2 and electrode tips 22a, 23a which is caused by buildup of swarf between them. By measuring the elapsed time from the cutting start time t₄ onward in this way, it is possible to judge if the cutting blades B1, B2 are in their normal states. Note that, the above upper limit time is stored in advance in the memory part 405.

The elapsed time successively measured by the time measuring part 411 of the present example can be displayed by the display device 50. Further, the elapsed time successively measured by the time measuring part 411 can be transmitted to the above cutting servo control part 403 and electrode servo control part 402. Further, the cutting servo control part 403 and the electrode servo control part 402 can use the received elapsed time to control the operations of the cutting servo motor 36 and electrode servo motor 24. For example, the cutting servo control part 403 compares the received elapsed time and the above upper limit time, and stops the cutting servo motor 36 when the received elapsed time exceeds the upper limit time. Further, the electrode servo control part 402 compares the received elapsed time and the above upper limit time, and inverts the rotational direction of the electrode servo motor 24 to move the movable electrode 22 in a direction away from the counter electrode 23 when the received elapsed time exceeds the upper limit time.

Next, the distance measuring part 412 of the present example has the function of measuring the distance between the position of the movable electrode 22 at the cutting start time t₄, that is, the contact start position P₁, and the predetermined initial cutting start position. The “initial cutting start position” referred to here means the position of the movable electrode 22 at the time when the increment amount ΔI of the current value of the cutting servo motor 3 reaches the threshold value th₁ in the initial tip dressing process of a new movable electrode 22 and counter electrode 23. This initial cutting start position is stored in advance in the memory part 405. Further, when the distance between the cutting start position P₁ and the initial cutting start position exceeds a predetermined upper limit distance, there is a possibility that the movable electrode 22 and the counter electrode 23 are excessively cut. By measuring the distance between the cutting start position P₁ and the initial cutting start position in this way, it is possible to judge if the movable electrode 22 and the counter electrode 23 have reached the ends of their lifespans.

The distance successively measured by the distance measuring part 412 of the present example can be displayed by the display device 50. Further, the distance successively measured by the distance measuring part 412 can be transmitted to the above cutting servo control part 403 and electrode servo control part 402. Further, the cutting servo control part 403 and the electrode servo control part 402 can use the distance received from the distance measuring part 412 to control operations of the cutting servo motor 43 and electrode servo motor 24. For example, the cutting servo control part 403 compares the distance received from the distance measuring part 412 and the above upper limit distance, and stops the cutting servo motor 36 when the received distance exceeds the upper limit distance. Further, the electrode servo control part 402 compares the distance received from the distance measuring part 412 and the above upper limit distance, and inverts the rotational direction of the electrode servo motor 24 to move the movable electrode 22 in a direction away from the counter electrode 23 when the received distance of movement exceeds the upper limit distance.

Next, the alarm part 413 of the present example has the function of monitoring the states of the devices during the tip dressing process, and outputting an alarm if there is some sort of abnormality. More specifically, the alarm part 413 of the present example can output an alarm to the display device 50 to the effect that the elapsed time measured by the time measuring part 411 has exceeded the upper limit time. Further, on receiving the alarm, the display device 50 can display an alarm message to notify the user that the cutting blades B1, B2 are in abnormal states, for example. Similarly, the alarm part 413 of the present example can output an alarm to the display device 50 to the effect that the distance measured by the distance measuring part 412 has exceeded the upper limit distance. Further, on receiving the alarm, the display device 50 can display an alarm message to notify the user that the movable electrode 22 and the counter electrode 23 have reached the ends of their lifespans, for example.

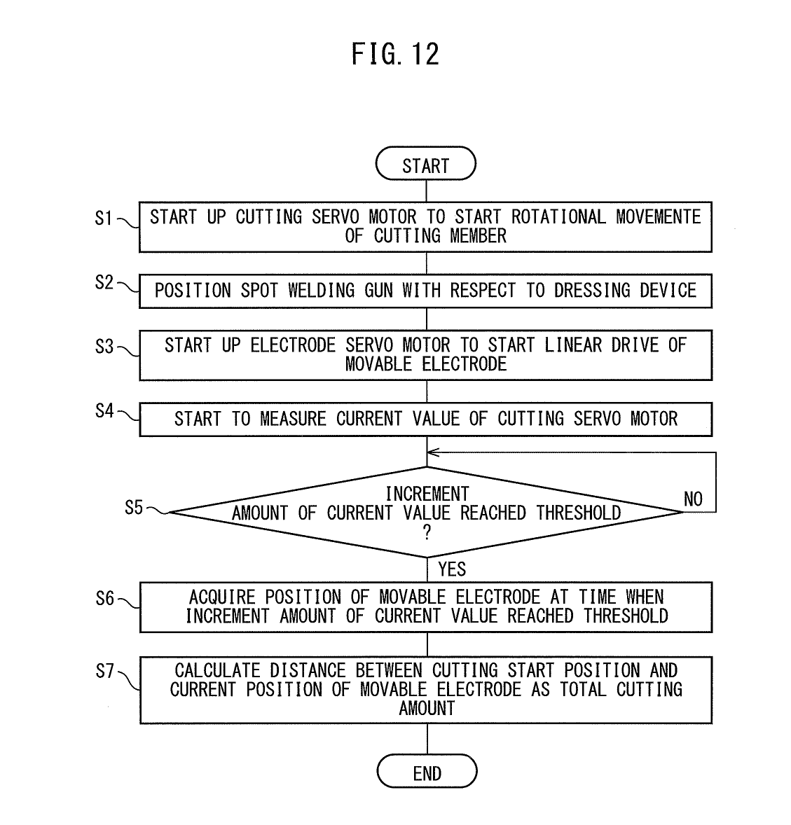

Next, the operations of each device in the tip dressing process of the present example will be outlined. FIG. 12 is a flow chart which shows the procedure in which the control device 40 calculates the total cutting amount C in the tip dressing process of the present example. As shown in FIG. 12, first, at step S1, the cutting servo control part 403 starts up the cutting servo motor 36 to start rotational movement of the cutting member 35. After that, due to feedback control of the cutting servo motor 36, the cutting member 35 accelerates at a certain acceleration, and then continues rotating at a certain rotational speed. Next, at step S2, the robot servo control part 401 positions the spot welding gun 20 with respect to the dressing device 30. The counter electrode tip 23a of the spot welding gun 20 thus comes into contact with the downward cutting blade B2 of the cutting member 35 (see FIG. 4).

Next, at step S3, the electrode servo control part 402 starts up the electrode servo motor 24 to start linear movement of the movable electrode 22. The movable electrode tip 22a of the spot welding gun 20 is thus moved toward the upward cutting blade B1 of the cutting member 35. Next, at step S4, the detection part 406 starts to measure the current value of the cutting servo motor 36. After that, the detection part 406 repeatedly measures the current value of the cutting servo motor 36 at a predetermined cycle. Further, the movable electrode tip 22a of the spot welding gun 20 comes into contact with the upward cutting blade B1 of the cutting member 35, whereupon the contact pressure between the electrode tips 22a, 23a and the cutting member 35 is gradually increased up to a predetermined pressure value, due to feedback control of the electrode servo motor 24. Next, at step S5, the judgment part 407 judges if the increment amount ΔI of the current value which was detected by the detection part 406 has reached the threshold value th₁. Further, when the increment amount ΔI of the current value has not reached the threshold value th₁ (step S5, NO), similar judgment is repeated for the increment amount ΔI which is successively detected by the detection part 406. Further, when the increment amount ΔI of the current value has reached the threshold value th₁ (step S5, YES), the flow chart proceeds to the later explained step S6.

Next, at step S6, the acquisition part 408 acquires the position of the movable electrode 22 at the time when the increment amount ΔI of the current value has reached the threshold value th₁ from the encoder 25 of the electrode servo motor 24. The thus acquired position of the movable electrode 22, that is, the position of the movable electrode 22 at the cutting start time t₄, is temporarily stored in the memory part 405. As explained above, in the tip dressing process of the present example, the position of the movable electrode 22 at the cutting start time t₄ is deemed as the cutting start position P₁ of the electrode tips 22a, 23a by the cutting member 35 (see FIG. 11). After that, due to feedback control of the electrode servo motor 24, the contact pressure between the electrode tips 22a, 23a and the cutting member 35 is maintained at a predetermined pressure value, and therefore the cutting of the electrode tips 22a, 23a by the cutting member 35 is continued.

Next, at step S7, the calculation part 409 calculates the total cutting amount C at the current time. More specifically, the calculation part 409 calculates the distance between the cutting start position P₁ of the movable electrode 22 which is stored in the memory part 405, and the current position P₂ of the movable electrode 22 which the acquisition part 408 successively acquires. As explained above, in the tip dressing process of the present example, the distance C between the cutting start position P₁ and the current position P₂ which is successively calculated by the calculation part 409 is deemed as the total cutting amount of the electrode tips 22a, 23a (see FIG. 11). In the above way, the control device 40 of the present example has the function of a calculation device for calculating the total cutting amount C of the electrode tips 22a, 23a by the cutting member 35 of the dressing device 30.

In the above way, the tip dressing system S of the present example judges if the increment amount ΔI of the current value of the cutting servo motor 36 for driving the cutting blades B1, B2 has reached a predetermined threshold value th₁, and then calculates the total cutting amount C of the movable electrode 22 and the counter electrode 23 based on the movement distance covered by the movable electrode 22 when it moves toward the counter electrode 23 from the position P₁ where the increment amount of ΔI reaches the threshold value th₁. That is, the tip dressing system S of the present example judges whether cutting of the movable electrode 22 and the counter electrode 23 has been started based on the increment amount ΔI of the current value of the cutting servo motor 36 on the dressing device 30 side. Here, the spot welding gun 20 has a power transmission part with a complicated structure which incorporates a ball screw and toothed belt etc. On the other hand, the dressing device 30 only has a power transmission part with a simple structure which incorporates a small number of gears. Therefore, the fluctuations in the current value or drive torque value of the cutting servo motor 36 which may occur due to the internal friction and elastic deformation etc. of the power transmission part are smaller than the fluctuations of the current value or drive torque value of the electrode servo motor 24 which may occur due to the same reasons. Further, the power transmission part of the dressing device 30 has a simple structure and hence a high rigidity, and therefore it is expected that the majority of the reaction force which is applied from the movable electrode 22 and the counter electrode 23 to the cutting member 35 is transmitted to the cutting servo motor 36 without being absorbed. Therefore, according to the tip dressing system S of the present example, it is possible to accurately estimate when the cutting member 35 started the cutting of the movable electrode 22 and the counter electrode 23, and therefore it is possible to accurately calculate the total cutting amount C of the movable electrode 22 and the counter electrode 23 by the cutting member 35.

Further, in a general spot welding system, although a spot welding gun needs to be changed in accordance with type, shape, etc. of welding base materials, a dressing device does not need to be changed in accordance with type of workpieces to be processed, i.e. electrode tips. This is because the dressing device only performs the simple process of cutting the electrode tips. Therefore, the above-mentioned threshold value th₁ of the increment amount ΔI of the current value, the threshold value th₂ of the increment amount per unit time ΔI/Δt of the current value, the target value of the cutting amount C of the electrode tip, etc. should only be determined once at the time of introduction of the system. Furthermore, since the frequency of use of the dressing device in a general tip dressing system is lower than that of a spot welding gun, there is little possibility that the behavior of the current or drive torque of the servo motor of a dressing device greatly change after system introduction. On the other hand, the behavior of the current or drive torque of the servo motor of the spot welding gun tends to greatly change due to deterioration over time.

The present invention is not limited to the above-mentioned embodiments and can be modified in various ways within the scope described in the claims. For example, the control device 40 in the tip dressing system S of the present embodiment does not have to be provided with all of the above-mentioned component elements. At least part of these component elements may be devices independent from the control device 40. Therefore, at least one of the above-mentioned robot servo control part 401, electrode servo control part 402, and cutting servo control part 403 may also be implemented in the system as a device separate from the control device 40 which serves as the above-mentioned calculation device. Further, the spot welding gun 20 in the tip dressing system S in the present embodiment is not limited to only a C-type welding gun which has the above-mentioned structure. For example, the spot welding gun may also be an X-type welding gun which has a structure with electrodes being attached to a pair of gun arms operated by a press cylinder. Further, the dimensions, shapes, materials, etc. of the above-mentioned parts are only examples. Various dimensions, shapes, materials, etc. can be employed for achieving the effects of the present invention.

### Effect of Invention

According to the first aspect of the present invention, the system judges if an increment amount of the load on a servo motor for driving cutting blades has reached a predetermined threshold value, and then calculates a cutting amount of the movable electrode and counter electrode based on a movement distance covered by a movable electrode when it is moved toward a counter electrode from the position where the increment amount of the load has reached a threshold value. That is, according to the first aspect, the system judges whether the cutting of the movable electrode and the counter electrode has been started, based on the increment amount of the load on the servo motor on the dressing device side. Normally, the dressing device only has a power transmission part with a simple structure incorporating a small number of gears, and therefore fluctuations of the current value or drive torque value of the servo motor due to internal friction and elastic deformation etc. of the power transmission part are comparatively small. Further, the power transmission part of the dressing device has a high rigidity, and therefore it is expected that the majority of the reaction force which is applied from the movable electrode and the counter electrode to the cutting blades is transmitted to the servo motor without being absorbed. Therefore, according to the first aspect, it is possible to accurately estimate when the cutting blades have started the cutting of the movable electrode and the counter electrode, and therefore it is possible to accurately calculate the cutting amount of the movable electrode and the counter electrode by the cutting blades.

According to the second aspect of the present invention, it is possible to simply detect the increment amount of the load applied to the servo motor, by measuring either the current value through the servo motor on the dressing device side or the drive torque value generated by the servo motor.

According to the third aspect of the present invention, the system judges whether the cutting of the movable electrode and the counter electrode has been started, based on the increment amount per unit time of the load of the servo motor, and therefore it is possible to accurately determine when the cutting has been started even if the cutting resistance of the movable electrode and the counter electrode is relatively small and thus the increment amount of the load is relatively small.

According to the fourth aspect of the present invention, it is possible to accurately judge if the cutting of the movable electrode and the counter electrode has been started, by using as the reference value, the current value during the period when the load on the servo motor on the dressing device side is substantially constant.

According to the fifth aspect of the present invention, the cutting amount of the movable electrode and the counter electrode is repeatedly calculated at a predetermined cycle, and therefore the user can successively confirm the cutting amount at the present times.

According to the sixth aspect of the present invention, the cutting blades are immediately stopped when the cutting amount of the movable electrode and the counter electrode reaches the target value, and therefore it is possible to prevent the movable electrode and the counter electrode from being excessively cut beyond the target value.

According to the seventh aspect of the present invention, the movable electrode is separated from the cutting blade immediately after the cutting amount of the movable electrode and the counter electrode reaches the target value, and therefore it is possible to prevent the movable electrode and the counter electrode from being excessively cut beyond the target value.

According to the eighth aspect of the present invention, an alarm is output to the outside when the cutting time of the movable electrode and the counter electrode by the cutting blades reaches a predetermined upper limit time, and therefore it is possible to notify the user of the fact that the cutting blades are abnormal in some way.

According to the ninth aspect of the present invention, the system calculates the cutting amount of each of the movable electrode and the counter electrode, in addition to the total cutting amount of the movable electrode and counter electrode, and therefore the user can confirm the states of use of the movable electrode and the counter electrode. Consequently, it is possible to improve the quality of the spot welding.

According to the 10th aspect of the present invention, the system stores time series data which shows the cutting amount of the movable electrode and the counter electrode, and therefore the user can easily estimate the lifespans of the movable electrode and the counter electrode, and determine the periods for replacing the movable electrode and counter electrode.

According to the 11th aspect of the present invention, the time series data which shows the cutting amount of the movable electrode and the counter electrode is displayed on the display device in the system, and therefore the user can confirm the content of the time series data even if the calculation device itself is not provided with a display device.

According to the 12th aspect of the present invention, the cutting is suspended if the position of the movable electrode at the time when the cutting blades starts the cutting is outside the allowable range, and therefore it is possible to prevent the movable electrode and the counter electrode from being further cut once reaching the ends of their lifespans.

According to the 13th aspect of the present invention, an alarm is output to the outside if the position of the movable electrode at the time when the cutting blades starts the cutting is outside the allowable range, and therefore it is possible to notify the user of the fact that the movable electrode and the counter electrode have reached the ends of their lifespans.

1. A tip dressing system comprising:
a spot welding gun which has a movable electrode, a counter electrode which faces said movable electrode, a servo motor which moves said movable electrode with respect to said counter electrode, and an encoder which measures a position of said movable electrode,
a dressing device which has cutting blades for cutting the front end parts of said movable electrode and said counter electrode, and a servo motor which drives said cutting blades, and
a calculation device which calculates a cutting amount at the time when said cutting blades cut the front end parts of said movable electrode and said counter electrode, wherein
said calculation device comprises:
a detection part which detects an increment amount of load which is applied to the servo motor of said dressing device,
a judgment part which judges if the increment amount of said load has reached a predetermined threshold value,
an acquisition part which acquires the position of said movable electrode which is measured by said encoder, and
a calculation part which calculates said cutting amount based on the distance which is covered by said movable electrode when said movable electrode is moved toward said counter electrode from the position where the increment amount of said load reaches said threshold value.

2. The tip dressing system according to claim 1, wherein
said detection part detects the increment amount of said load, based on an increment amount of the current value through said servo motor of the dressing device or an increment amount of the drive torque value which is generated by said servo motor of the dressing device.

3. The tip dressing system according to claim 1, wherein
said detection part detects the increment amount of said load per unit time.

4. The tip dressing system according to claim 1, wherein
said detection part detects the increment amount of said load from a predetermined reference value.

5. The tip dressing system according to claim 1, wherein
said calculation part repeatedly calculates said cutting amount at a predetermined cycle.

6. The tip dressing system according to claim 5, wherein
said calculation device further comprises a first control part which compares said cutting amount repeatedly calculated by said calculation part with a predetermined target value to stop the servo motor of said dressing device when said cutting amount reaches said target value.

7. The tip dressing system according to claim 6, wherein
said calculation device further comprises a second control part which inverts the rotational direction of the servo motor of said spot welding gun to move said movable electrode in a direction away from said counter electrode when said cutting amount repeatedly calculated by said calculation part reaches said target value.

8. The tip dressing system according to claim 1, wherein
said calculation device further comprises:
a time measuring part which measures an elapsed time during which said cutting blades cut the front end parts of said movable electrode and said counter electrode, and
a first alarm part which outputs an alarm when said measured elapsed time has reached a predetermined upper limit time.

9. The tip dressing system according to claim 1, wherein
said calculation device further comprises a distribution part which distributes said cutting amount calculated by said calculation part at a predetermined ratio to calculate a cutting amount on said movable electrode side and a cutting amount on said counter electrode side.

10. The tip dressing system according to claim 9, wherein
said calculation device further comprises a memory part which stores time series data of said cutting amount, the cutting amount on said movable electrode side, and the cutting amount on said counter electrode side.

11. The tip dressing system according to claim 10, further comprising a display device which can display said time series data.

12. The tip dressing system according to claim 1, wherein
said calculation device further comprises:
a distance measuring part which measures a distance between a position of said movable electrode at the time when the increment amount of said load reaches said threshold value, and a predetermined initial position of said movable electrode, and
a third control part which stops the servo motor of said dressing device when the distance measured by said distance measuring part exceeds a predetermined upper limit distance.

13. The tip dressing system according to claim 12, wherein
said calculation device further comprises a second alarm part which outputs an alarm when the distance measured by said distance measuring part exceeds said upper limit distance.
